(19) United States
(12) Patent Application Publication
(10) Pub. No.: US 2026/0225476 A1
(43) Pub. Date: Aug. 6, 2026

(54) SHORTING SWITCH TO REDUCE GROUND LEAKAGE CURRENT IN INDUCTIVE CHARGING

(71) Applicant: Tesla, Inc., Austin, CA (US)

(72) Inventors: Xuan Zhang, Sunnyvale, CA (US); Mehmet Ozbek, San Francisco, CA (US)

(21) Appl. No.: 19/157,480

(22) PCT Filed: Feb. 27, 2024
(86) PCT No.: PCT/US2024/017505

§ 371 Date: Aug. 18, 2025

Related U.S. Application Data
(60) Provisional application No. 63/487,559, filed on Feb. 28, 2023.
(60) Provisional application No. 63/487,565, filed on Feb. 28, 2023.

(51) Int. Cl. B60L 53/122; H02M 7/797

(52) U.S. Cl. CPC B60L 53/122; H02M 7/797; B60L 2210/40

(57) ABSTRACT

The present disclosure relates to a bidirectional shorting switch that can be used to short a resonant tank to reduce leakage current associated with a wireless charging pad configured for wireless power transfer. In some embodiments, the wireless charging 2024/182409 pad includes a resonant tank and a bidirectional switch. The resonant tank has a first tank terminal and a second tank terminal, and the resonant tank includes a coil. The bidirectional switch has a first switch terminal and a second switch terminal. The first switch terminal is connected to the first tank terminal, and the second switch terminal is connected to the second tank terminal. The bidirectional switch is configured to cause a common mode voltage across the coil to be reduced.

### CROSS-REFERENCE TO PRIORITY APPLICATIONS

This application claims priority to U.S. Provisional Patent Application No. 63/48,7565, entitled “WIRELESS CHARGING CIRCUIT TOPOLOGY,” filed on Feb. 28, 2023, and U.S. Provisional Patent Application No. 63/48,7559, entitled “SHORTING SWITCH TO REDUCE GROUND LEAKAGE CURRENT IN INDUCTIVE CHARGING,” filed on Feb. 28, 2023, the disclosures of each which are hereby incorporated by reference in their entireties and for all purposes.

### TECHNICAL FIELD

The present disclosure relates to systems and methods for wireless charging. More particularly, embodiments of the present disclosure relate to wireless charging systems and mechanisms for charging vehicles.

### BACKGROUND

Generally described, inductive charging, commonly referred to as wireless charging, is a type of wireless power transfer. Inductive charging uses electromagnetic induction to generate, or otherwise provide, electricity to devices without necessarily requiring physical electrical connectivity. Specifically, various devices can be placed near a charging station or inductive pad without being precisely aligned or making electrical contact, a physical dock, an electric plug, and the like. Such devices can include, but are not limited to, vehicles, manufacturing equipment, consumer electronics, medical devices, and the like.

### SUMMARY

The systems, methods and devices of this disclosure each have several innovative embodiments, no single one of which is solely responsible for all of the desirable attributes disclosed herein. Details of one or more implementations of the subject matter described in this specification are set forth in the accompanying drawings and the description below.

In some aspects, the techniques described herein relate to a wireless charging pad with reduced leakage current, the wireless charging pad including: a resonant tank having a first tank terminal and a second tank terminal, the resonant tank including a coil; and a bidirectional switch having a first switch terminal and a second switch terminal, the first switch terminal connected to the first tank terminal and the second switch terminal connected to the second tank terminal, wherein the bidirectional switch is configured to cause a common mode voltage across the coil to be reduced, and wherein the wireless charging pad is configured for wireless power transfer.

In some aspects, the techniques described herein relate to a wireless charging pad, wherein the bidirectional switch includes a first transistor and a second transistor, wherein the first transistor and the second transistor are connected back-to-back.

In some aspects, the techniques described herein relate to a wireless charging pad, wherein the first transistor and the second transistor are field effect transistors (FETs), wherein a drain of the first transistor is connected to the first switch terminal, wherein a drain of the second transistor is connected to the second switch terminal, and wherein a source of the first transistor and a source of the second transistor are connected to each other.

In some aspects, the techniques described herein relate to a wireless charging pad, further including a H bridge circuit, wherein the first tank terminal and the first switch terminal are connected to a first switching node of the H bridge circuit, and wherein the second tank terminal and the second switch terminal are connected to a second switching node of the H bridge circuit.

In some aspects, the techniques described herein relate to a wireless charging pad, further including a stacked half bridge circuit, wherein the first tank terminal and the first switch terminal are connected to a first switching node of the stacked half bridge circuit, and wherein the second tank terminal and the second switch terminal are connected to a second switching node of the stacked half bridge circuit.

In some aspects, the techniques described herein relate to a wireless charging pad, wherein the stacked half bridge circuit includes a first half bridge including field effect transistors, and a second half bridge including field effect transistors.

In some aspects, the techniques described herein relate to a wireless charging pad, wherein a the one field effect transistor of the first half bridge and one field effect transistor of the second half bridge are connected in series between the first switching node and the second switching node.

In some aspects, the techniques described herein relate to a wireless charging pad, wherein the bidirectional switch includes two field effect transistors connected back-to-back.

In some aspects, the techniques described herein relate to a wireless charging pad, wherein the bidirectional switch further includes a capacitor connected in series between two field effect transistors.

In some aspects, the techniques described herein relate to a wireless charging pad, wherein the coil is a segmented coil.

In some aspects, the techniques described herein relate to a wireless charging pad, wherein the wireless charging pad is a vehicle pad including terminals configured to connect to a battery pack.

In some aspects, the techniques described herein relate to a wireless charging pad, wherein the wireless charging pad is a ground pad including an electrical connector configured to connect to a power source.

In some aspects, the techniques described herein relate to a method of wireless power transfer with reduced leakage current, the method including: energizing a ground pad; and wirelessly transferring power from the ground pad to a vehicle pad of a vehicle, wherein the vehicle includes a battery pack and is configured to charge the battery pack based on the wirelessly transferring power, and wherein at least one of the vehicle pad or the ground pad includes a bidirectional shorting switch across a resonant circuit.

In some aspects, the techniques described herein relate to a method, wherein the bidirectional shorting switch includes a first transistor and a second transistor, wherein the first transistor and the second transistor are connected back-to-back.

In some aspects, the techniques described herein relate to a method, wherein the bidirectional shorting switch further includes a capacitor connected in series between the first transistor and the second transistor.

In some aspects, the techniques described herein relate to a method, wherein the resonant circuit includes an inductive coil and one or more resonant capacitors.

In some aspects, the techniques described herein relate to a method, wherein the vehicle pad is configured to provide a voltage of up to 800 Volts to the battery pack.

In some aspects, the techniques described herein relate to a wireless charging converter including: a first resonant tank including a first coil; and a first electrical switch shunted across the first resonant tank, wherein the first electrical switch is configured to cause a common mode voltage across the first coil to be reduced for wireless charging.

In some aspects, the techniques described herein relate to a wireless charging converter, further including: a second resonant tank including a second coil; and a second electrical switch shunted to the second resonant tank, wherein the second electrical switch is configured to adjust a second common mode voltage on the second coil for charging a battery pack of a vehicle.

In some aspects, the techniques described herein relate to a wireless charging converter, wherein the first resonant tank and the first electrical switch are in a vehicle pad attached to the vehicle, and where the second resonant tank and the second electrical switch are in a ground pad that is connected to an energy source for charging the battery pack of the vehicle.

In some aspects, the techniques described herein relate to a wireless charging converter, wherein the first electrical switch includes two field effect transistors (FETs) connected back-to-back.

In some aspects, the techniques described herein relate to a wireless charging converter, wherein the second electrical switch includes two additional FETs and a capacitor connected in series between the two additional FETs.

In some aspects, the techniques described herein relate to a wireless charging converter, wherein the second electrical switch includes two additional transistors connected back-to-back.

In some aspects, the techniques described herein relate to a wireless charging system including the wireless charging pad.

### BRIEF DESCRIPTION OF THE DRAWINGS

Throughout the drawings, reference numbers are re-used to indicate correspondence between referenced elements. The drawings are provided to illustrate examples of the subject matter described herein and not to limit the scope thereof.

Embodiments of the present disclosure are described with reference to the accompanying drawings, in which like reference characters reference like elements, and wherein:

FIG. 1A illustrates an example wireless charging environment in which embodiments of the present disclosure can be implemented.

FIG. 1B is a block diagram illustrating the example wireless charging environment of FIG. 1A in accordance with some embodiments of the present disclosure.

FIG. 1C illustrates a block diagram of a ground pad that may function as a wireless charging device in accordance with some embodiments of the present disclosure.

FIG. 2A illustrates an example wireless charging system with and additional DC/DC converter.

FIG. 2B illustrates an example wireless charging system with and additional DC/DC converter.

FIG. 3A illustrates an example circuit topology of a wireless charging converter in accordance with some embodiments of the present disclosure.

FIG. 3B illustrates an example circuit topology of a wireless charging converter in accordance with some embodiments of the present disclosure.

FIG. 4A shows example waveforms illustrating operation of the example circuit topology of FIG. 3A in accordance with some embodiments of the present disclosure.

FIG. 4B shows example waveforms illustrating operation of the example circuit topology of FIG. 3B in accordance with some embodiments of the present disclosure.

FIGS. 5A-5B illustrate example circuit topologies including bidirectional shorting switches in accordance with some embodiments of the present disclosure.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals and/or terms can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. The headings are provided for convenience only and do not impact the scope or meaning of the claims.

Wireless charging devices are usable to wirelessly charge a vehicle, such as an electric vehicle with a battery pack. A wireless charging device (e.g., a ground pad) may cause power received from an external source, such as the grid, solar cell(s), and so on, to be wirelessly transmitted (e.g., via induction) to the electric vehicle. A ground pad may be positioned under a vehicle pad of an electric vehicle to charge the electric vehicle. A wireless charging direct current (DC)/DC converter (also referred to as aggregated DC/DC power converter) generally includes a DC/alternating current (AC) inverter inside the ground pad, and an AC/DC rectifier inside the vehicle pad. Power can be transmitted wirelessly from the ground pad to the vehicle pad. Wireless charging disclosed herein can be applied to any suitable vehicle, including electric vehicles with a battery pack and hybrid vehicles that include an internal combustion engine and a battery pack.

Generally described, one or more aspects of the present disclosure relate to systems and methods for wirelessly charging battery packs of vehicles, which can have a relatively wide range of battery voltages. Illustratively, aspects of the present disclosure relate to wireless charging circuits that are configurable for operating under different input and output voltages. In some embodiments, a wireless charging DC/DC converter may be configured on a topology level during manufacturing time to set the converter voltage gain ratio of a converter that includes a particular vehicle pad. The same circuit elements can be connected differently by electrical connectors, such as jumper cables, during manufacture in vehicle pads having different battery packs. Accordingly, these different vehicle pads together with the same ground pad in a wireless charger can accommodate a wide battery voltage range or a wide range of battery load impedance without utilizing an additional DC/DC converter. More specifically, wireless charging DC/DC converters including the same ground pad of a wireless charger can generate a wide range of output voltage levels with different vehicle pads to charge different battery packs with different nominal and/or maximum voltage ratings. For example, the wireless charging DC/DC converter can be configured to interface with battery packs with nominal and/or maximum voltage ratings including, but not limited to, 400 Volts (V) or 800V.

In some embodiments, one or more bidirectional shorting switches can be integrated into the wireless charging DC/DC converter. For example, a bidirectional shorting switch can be deployed on a vehicle side (e.g., inside a vehicle pad) of the wireless charging DC/DC converter. As another example, a bidirectional shorting switch can be deployed on a ground side (e.g., inside a ground pad) of the wireless charging DC/DC converter. In certain applications, there can be one bidirectional shorting switch on the vehicle side and another bidirectional shorting switch on the wireless charger side. A bidirectional shorting switch can provide alternating current (AC) shorting across a resonant tank. The one or more bidirectional shorting switches can maintain a generally constant common-mode voltage on a ground pad coil and/or a vehicle pad coil. As such, leakage currents associated with the wireless charging DC/DC converter can be reduced using bidirectional shorting switch(es). This can reduce energy consumption, and/or minimize conducted and radiative emissions.

In certain traditional designs, wireless charging systems typically include an additional DC/DC converter relative to embodiments of wireless charging systems disclosed herein, either before or after a wireless charging DC/DC converter, to accommodate a wide battery voltage range and a wide battery load impedance range. For example, to charge battery packs with nominal and/or maximum voltages at 400V and 800V respectively, one additional DC/DC converter can be employed relative to a just converter that includes a vehicle pad and a ground pad. The additional DC/DC converter can increase the range of the wireless charger voltage gain. The additional DC/DC converter may be a buck and/or boost converter between the battery module and the wireless power receiver. Such approaches can involve extra cost for building the wireless charging system. Furthermore, the additional DC/DC converter may increase the weight of the wireless charging system. Additionally, energy loss may be incurred with the deployment of the additional DC/DC converter between the battery module and the wireless power receiver.

To avoid an additional DC/DC converter, other wireless charging systems can utilize variants of coil and resonant capacitors to support different battery charging voltages. The variations on the coils and/or resonant capacitors, however, cause extra complexity in the supply chain and production management.

To address at least a portion of the above problems, a wireless charging DC/DC converter or a topology thereof is disclosed in accordance with some embodiments of the present disclosure. In some embodiments, the wireless charging DC/DC converter can be configured (e.g., using jumpers) on the topology level during manufacturing or assembly in a factory, to set the converter voltage gain ratio in particular vehicle pads for a corresponding battery pack of a vehicle. Additionally, active switches (e.g., relays or semiconductor switches) can be deployed on a PCB and be operated (e.g., turning on or off) to reconfigure a wireless charging DC/DC converter on the field (e.g., outside of a factory for manufacturing or assembly). This can accommodate a wide battery voltage range or a wide range of battery load impedance for wireless charging with the same wireless charger together with various vehicle pads. For example, the vehicle pad can be configured during manufacturing by one or more jumpers installed on a printed circuit board (PCB), to set the circuit topology of the vehicle pad to achieve a converter voltage gain ratio according to the desired battery pack voltage range (e.g., from 200 V to 800 V) and/or the wide range of battery load impedance. Advantageously, based on the embodiments of the present disclosure, a relatively wide battery pack voltage range can be achieved using a ground pad and various vehicle pad topologies without using an additional DC/DC converter. A same set of hardware (e.g., same transistors, same coils, same resonant capacitors, or the like) can be configured into different circuit topologies for different battery packs to streamline the manufacturing process. For each circuit topology, the converter can provide further voltage regulation around its nominal voltage, by applying controls on one or more of duty cycle, switching frequency, or phase shift between the primary side and the secondary side.

In some embodiments, the wireless charging DC/DC converter disclosed adopts the same coil and/or same resonant capacitors to facilitate battery charging across different vehicle battery charging platforms. The wireless charging DC/DC converter may exploit identical or a single PCB to match different input and/or output voltages specified by different battery pack charging platforms. The wireless charging DC/DC converter may be associated with different PCB assemblies (PCBA) to support different vehicle battery charging platforms. Advantageously, the hardware design complexity and the cost of building a wireless charging system may be decreased by integrating the disclosed wireless charging DC/DC converter into the wireless charging system.

In some embodiments, a bidirectional shorting switch can short a resonant tank (e.g., a resonant capacitor in series with a ground pad coil) of a ground pad, and/or a bidirectional shorting switch can short a resonant tank (e.g., a resonant capacitor in series with a vehicle pad coil) of a vehicle pad. The bidirectional shorting switches can establish a generally constant common-mode voltage on a ground pad coil and/or a vehicle pad coil. Advantageously, leakage current associated with the ground pad coil and/or the vehicle pad coil can be reduced with such a bidirectional shorting switch, thereby reducing energy consumption, minimizing conducted and radiative emissions, and/or making the wireless charging DC/DC converter more power efficient.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicle charging mechanisms, power sources, interfaces and the like. Still further, although a specific DC/DC converter schematic for charging batteries and/or battery packs under different voltage levels will be described, such illustrative DC/DC converter schematic should not be construed as limiting. Accordingly, one skilled in the relevant art will appreciate that the aspects of the present application are not necessarily limited to application to any particular type of vehicle, vehicle charging infrastructure, data communications or illustrative interactions between vehicles, owners/users and wireless battery charging systems.

### Overview of Wireless Charging

Generally described, inductive charging, commonly referred to as wireless charging, is a type of wireless power transfer. Inductive charging uses electromagnetic induction to generate, or otherwise provide, electricity to devices without requiring physical electrical connectivity. Specifically, various devices can be placed near a charging station or inductive pad without needing to be precisely aligned or make electrical contact, a physical dock, an electric plug and the like. Such devices include, but are not limited to, vehicles, manufacturing equipment, consumer electronics, medical devices, and the like.

In accordance with aspects of the present application, inductive charging systems are configured to transfer energy through inductive coupling between components. An illustrative charging system includes a transferring component, which may be configured as a charging station or charging pad. An alternating current (e.g., an input current) from a power source passes through an induction coil in the charging station or pad. Based on the input current, the moving electric charge through the induction coil (e.g., a ground pad coil) creates (or elicits) a magnetic field. Illustratively, the strength of the magnetic field may fluctuate, at least in part, on changes or fluctuations in the input electric current's amplitude. The changing magnetic field creates an alternating electric current in an induction coil on a receiving device (e.g., a vehicle pad coil). The induced alternating current in the receiving device can then pass through a rectifier, converting the induced alternating current to a direct current. Finally, the receiving vehicle can include additional charging components and/or systems that utilize the converted direct current to charge battery systems, provide operating power, or a combination thereof.

Greater distances between ground pad and vehicle pad coils can be achieved when illustrative inductive charging systems use resonant inductive coupling components/techniques. More specifically, in some embodiments, a capacitor can be connected to each induction coil to create two LC circuits with a specific resonance frequency. The frequency of the alternating current is matched with the resonance frequency. Additionally, the matched frequency can be further chosen depending on a distance between the sending device and the receiver device with consideration for peak efficiency. Still further, use of other materials for the receiver coil such as silver-plated copper or sometimes aluminum to minimize weight and decrease resistance can be utilized for purposes of energy transfer efficiencies.

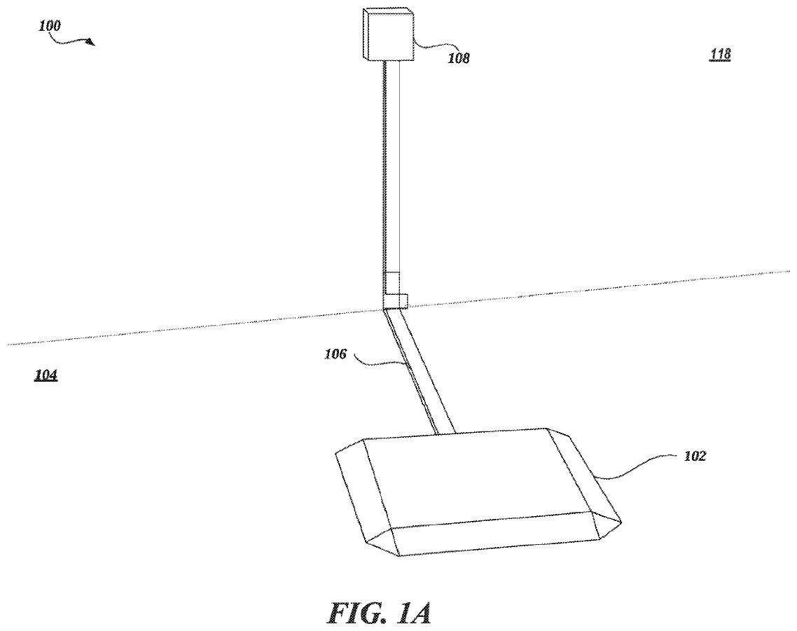

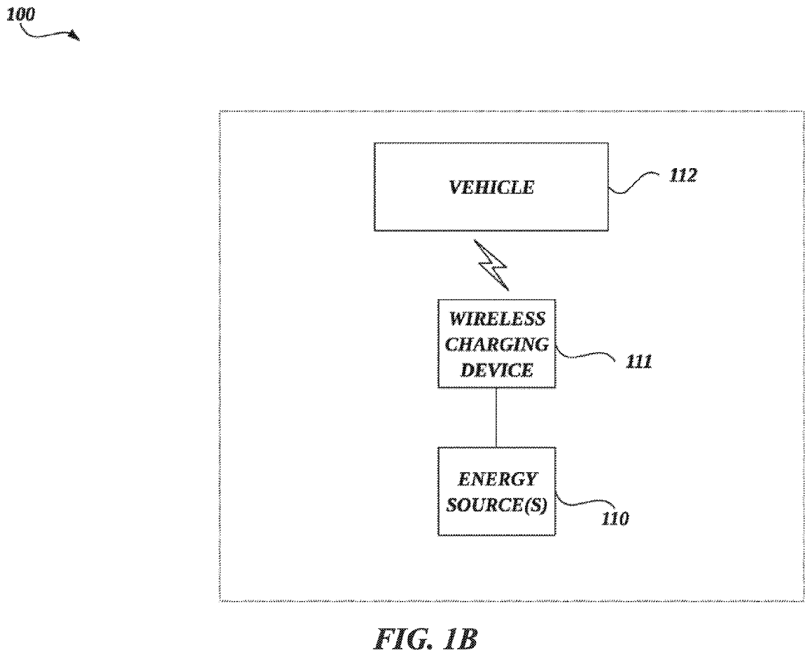

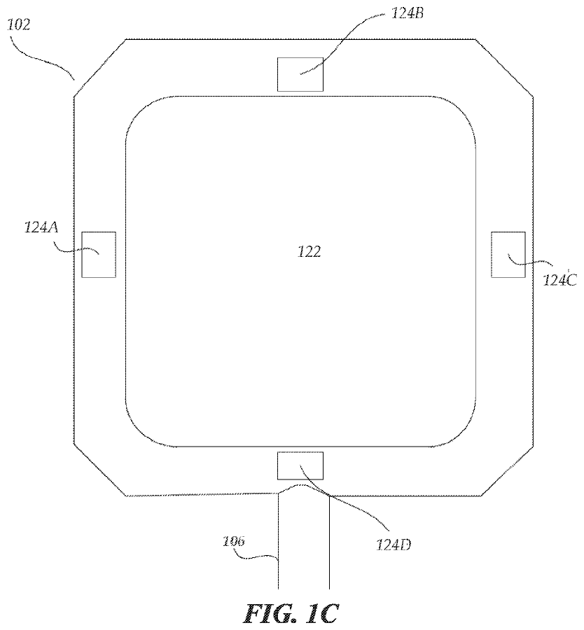

FIG. 1A is a diagram illustrative of an environment 100 for implementing an induction-based wireless charging system in accordance with various aspects of the present application. The environment 100 illustratively can correspond to commercial implementations, such as parking lots, parking stalls, charging booths, and the like. The environment 100 can correspond to private or other non-commercial implementations, such as private residences, etc. By way of an illustrative example, an implementation of an induction-based wireless charging system in a non-commercial implementation can include a ground pad 102 that is configured to generate variable magnetic fields in accordance with an induction charging methodology. As also illustrated in FIG. 1A, the ground pad 102, which can also be referred to as a transmitting component, can correspond to a stand-alone component that may be operable to be mounted or placed on a floor 104 or other planar surface. In some other embodiments, the ground pad 102 can be integrated or combined with other devices or components.

The ground pad 102 may be connected to a one or more power sources, such as an input from a utility company, real-time power sources (e.g., solar cells or wind energy sources), stored energy cells, or a combination thereof. The power sources are configured to provider the input alternating current as described herein. The ground pad 102 may be connected via direct electric connection 106 to the power source, such as via a junction box 108 located on a wall surface 118.

As illustrated in FIG. 1A, in one embodiment, the ground pad 102 corresponds to a form factor that allows for the location on the floor 104 for wirelessly charging with a vehicle having a vehicle pad coil. The ground pad 102 may have a form factor such that the vehicle may be located directly above a top surface of the ground pad 102. Illustratively, the dimensions of the ground pad 102 (e.g., the height and width of the ground pad 102) may be configured so that a distance between the top surface of the ground pad 102 and a bottom surface of the vehicle meets specific criteria, such as minimum distance between the ground pad coil and vehicle pad coil, maximum distance between the ground pad coil and the vehicle pad coil, and the like. In some embodiments, the vehicle or ground pad 102 (or combination) may be configured with additional components for adjusting (e.g., statically adjusting and/or dynamically adjusting) such distance or otherwise changing the relative orientation between the ground pad 102 and the vehicle.

In some embodiments, the ground pad 102 can be configured to charge a battery pack of a vehicle, wherein the battery pack can have a nominal voltage of over 200 Volts (e.g., a nominal voltage of about 350 Volts or 355 Volts) and a maximum voltage of 400 Volts. In some embodiments, the ground pad 102 can be configured to supply 800 Volts of direct current power. In some embodiments, the ground pad 102 can supply a voltage in a range from about 200 Volts to 800 Volts.

FIG. 1B illustrates a block diagram of the environment 100 including a wireless charging device 111 (e.g., the ground pad 102) in wireless communication with a vehicle 112, such as via induction-based magnetic fields. The wireless charging device 111 is further connected to one or more energy sources 110. Although the wireless charging device 111 is illustrated with a direct connection to the energy sources 110, at least some portion of the input alternating currently could also be provided via a wireless transmission method. Additionally, in embodiments with multiple power sources, the environment may also include various switching components to cause the selection of energy from individual energy sources 110 or a combination of energy sources 110.

FIG. 1C illustrates a block diagram of a ground pad 102 that may function as a wireless charging device 111 (shown in FIG. 1B). The ground pad 102 can include at least a ground pad coil 122 for causing the generation of magnetic fields from an input current provided from an energy source 110. As illustrated in FIG. 1C, the input current can be provided by a direct electric connection 106.

In some embodiments, the ground pad 102 can also include various sensor components 124 related to the charging process. By way of illustration, the sensor components 124A, 124B, 124C, 124D can be configured for various functions, such as detection of vehicle 112, detection of objects, measurement of distances to the vehicle, environmental sensors (e.g., temperature sensors, moisture sensors), pressure sensors, and the like. In an embodiment, the sensor components 124 can include radar sensors. The sensor components 124 can include logic and processing components related to the charging process including operational measurements, operational control, safety measurements, communication components and the like.

### Wireless Charging Systems With Wireless Charging Converter and Dc/dc Converter

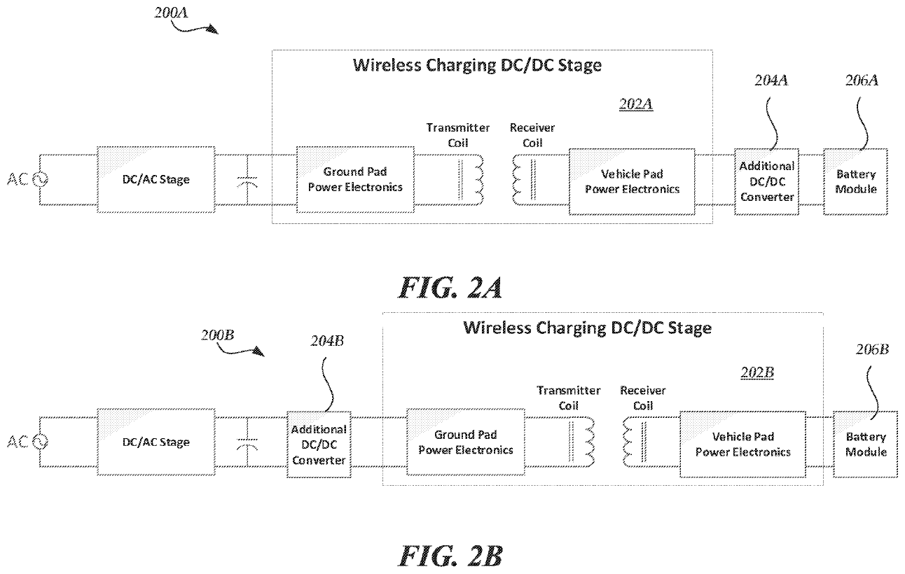

FIG. 2A illustrates an example wireless charging system 200A. As shown in FIG. 2A, the wireless charging system 200A includes a wireless charging DC/DC converter 202A and a DC/DC converter 204A. The DC/DC converter 204A is included on a vehicle side (e.g., within a vehicle pad) of the wireless charging system 200A to convert an output voltage from the DC converter 202A to a voltage for by a battery pack 206A of a vehicle. The battery pack 206A can be referred to as a battery coil. With the DC/DC converter 204A, the voltage level provided by the wireless charging DC/DC converter 202A can be adjusted to a voltage level specified for the battery pack 206A.

FIG. 2B illustrates an example wireless charging system 200B. As shown in FIG. 2B, the wireless charging system 200B includes a wireless charging DC/DC converter 202B and a DC/DC converter 204B. The DC/DC converter 204B is included on a ground side (e.g., within a ground pad) of the wireless charging system 200B to convert an output voltage from an DC/AC conversion stage to a voltage level such that the wireless charging DC converter 202B provides a voltage specified by a battery pack 206B of a vehicle.

The additional DC/DC converter 204A and/or 204B can be a buck and/or boost converter that may involve extra components and cost for the wireless charging system 200A or 200B. Furthermore, the DC/DC converter 204A and/or 204B may increase the weight of the wireless charging system 200A or 200B. Additionally, energy loss on the vehicle side may be incurred with the deployment of the additional DC/DC converter 204A between the battery pack 206A and portions of the wireless charging DC converter 202A on the vehicle side.

### Example Wireless Charging System

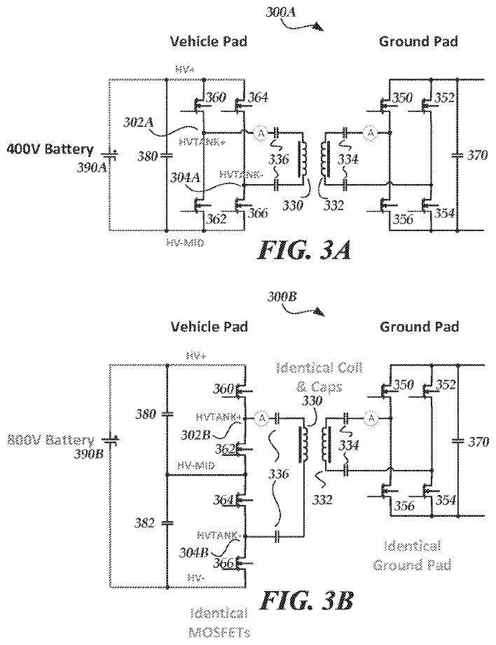

FIGS. 3A-3B illustrate an example circuit topology 300A and an example circuit topology 300B of a wireless charging DC/DC converter, where the topology of the vehicle pad can be configurable during manufacturing based on desired battery voltage ranges. More specifically, the vehicle pads with the circuit topologies 300A and 300B can be manufactured using the same coils (e.g., a vehicle pad coil 330), transistors 360-364, and resonant capacitors 336, which can be configured during manufacturing of the vehicle pads. Such vehicle pads together with the same ground pad can charge battery packs with different voltage ranges (e.g., maximum voltages of 400 V and 800 V). In some embodiments, the vehicle pads can be configured as the vehicle pad of either the circuit topology 300A or the circuit topology 300B by manipulating one or more connectors (e.g., jumpers) installed on a printed circuit board (PCB) of a vehicle pad. In other embodiments, instead of using jumpers, active switches (e.g., relays or semiconductor switches) can be deployed on a PCB and be operated (e.g., turning on or off) to reconfigure vehicle pads on the field (e.g., outside of a factory for manufacturing or assembly) for switching between the circuit topology 300A or the circuit topology 300B. Besides charging battery packs at various nominal and/or maximum voltages, the circuit topology 300A and the circuit topology 300B can further provide voltage regulation around nominal voltages through one or more of controlling duty cycle, switching frequency, or phase-shift associated with signals on the vehicle pad side and the ground pad side.

More specifically, FIG. 3A illustrates that circuit topology 300A is utilized to charge a battery pack 390A at a first voltage while FIG. 3B illustrates the circuit topology 300B is utilized to charge another battery pack 390B at a second voltage. The second voltage can be around double the first voltage. For example, the first voltage can be up to 400 V and the second voltage can be up to 800V. As illustrated in FIGS. 3A-3B, the circuit topology 300A or the circuit topology 300B each include at least a ground pad coil 332, a vehicle pad coil 330, capacitors 336 and 334. In the context of wireless charging, the ground pad and the vehicle pad may not be connected physically. Electric power may be provided from the ground pad (e.g., the ground pad 102 of FIG. 1A or the wireless charging device 111 of FIG. 1B) and the provided electric power may be wirelessly coupled to the vehicle pad (e.g., a part of the vehicle 112 of FIG. 1B) through the operations of the circuit topology 300A or circuit topology 300B. In some embodiments, electric power may be wirelessly transmitted from the ground pad (that is connected to an energy source, such as the energy source 110) to the vehicle pad through the link established between the ground pad coil 332 on the ground pad and the vehicle pad coil 330 on the vehicle pad.

As shown in FIG. 3A, the electric power from the ground pad is converted by the circuit topology 300A to charge a battery pack 390A that may be used to power a vehicle. The battery pack 390A can have a maximum voltage of 400 V, for example. In some embodiments, although not explicitly shown in FIG. 3A, the voltage level of the energy source to which the ground pad is connected may output a DC voltage below the maximum voltage of the battery pack 390A (e.g., 400V), which is then converted to a voltage for charging the battery pack 390A by the circuit topology 300A to charge the battery pack 390A.

As shown in FIG. 3A, the ground pad includes transistors 350, 352, 354, and 356 arranged in a H bridge topology. The ground pad also includes capacitors 334 and a ground pad coil 332 arranged as a resonant tank. Additionally, the ground pad may also include the capacitor 370. In the circuit topology 300A, the vehicle pad includes a resonant tank including a vehicle pad coil 330, capacitors 336, and transistors 360, 362, 364, and 366 arranged in a H bridge circuit. The H bridge circuit includes transistors 360, 362, 364, and 366 is illustrated to be in parallel or shunted with a capacitor 380. The transistors 350, 352, 354, 356 of the ground pad and the transistors 360, 362, 364, and 366 of the vehicle pad can be field effect transistors (FETs) as illustrated. For example, these transistors can be metal oxide semiconductor field effect transistors (MOSFETs), such as N-type MOSFETs and/or P-type MOSFETs. As illustrated, the transistors 350-356 and 360-366 are N-type FETs.

FIG. 3B illustrates that the wireless charging DC/DC converter that is configured to a different topology (e.g., the circuit topology 300B) than the wireless charging DC/DC converter of FIG. 3A. In particular, the vehicle pad includes power electronics that are arranged differently in FIG. 3B and FIG. 3A. Otherwise, the vehicle pads of the circuit topologies 300A and 300B can include instances of the same components. During manufacturing or assembly of the vehicle pads, these components can be arranged differently for the vehicle pads shown in FIGS. 3A and 3B to provide a different voltage conversion ratio. For instance, the wireless charging converter with the topology 300B shown in FIG. 3B can have about twice the voltage conversion ratio as the wireless converter with the topology 300A shown in FIG. 3A. The circuit topology 300B can generate DC voltage around twice the voltage as the circuit topology 300A.

As shown in FIG. 3B, transistors 360, 362, 364, and 366 of the vehicle pad are arranged as stacked half bridges. The stacked half bridges include two half bridges arranged in series with each other. A first half bridge (e.g., including transistors 360 and 362) of the vehicle pad of FIG. 3B is arranged the same as one of the half bridges in the vehicle pad of FIG. 3A. The first half bridge is in parallel with a capacitor 380 as illustrated in FIG. 3B. A second half bridge (e.g., including transistors 364 and 366) of the vehicle pad of FIG. 3B is arranged in series with the first half bridge and between HV-MID and HV-nodes. The second half bridge is in parallel with a capacitor 382 as illustrated in FIG. 3B.

The voltage pad of the circuit topology 300B can be used in a vehicle having a battery pack 390B with a higher voltage specification than a vehicle with a battery pack 390A of the circuit topology 300A. As one example, the vehicle pad of the circuit topology 300B can be used in a vehicle with a maximum battery pack voltage of 800 V and the vehicle pad of the circuit topology 300A can be used in a vehicle with a maximum battery pack voltage of 400 V.

The hardware components (e.g., the transistors 360, 362, 364, and 366, the capacitors 336, the vehicle pad coil 330, the ground pad coil 332, the capacitors 334, the transistors 350, 352, 354, and 356) associated with the ground pad and the vehicle pad may be the same as those shown in FIG. 3A. In some instances, the transistors (e.g., the transistors 360, 362, 364, and 366) of the vehicle pads of FIGS. 3A and 3B can be 650 V MOSFETs. The vehicle pad coil 330, the ground pad coil 332, and capacitors 336, 334, and 370 in the ground pad and vehicle pad in FIG. 3B and FIG. 3A can also be the same. Further, in FIG. 3B, the energy source to which the ground pad is connected may output the same DC voltage as in FIG. 3A. In some other embodiments, the ground pads in FIGS. 3A-3B may be connected to different types of energy sources that provide different levels of input voltages to the circuit topology 300A and the circuit topology 300B.

In some embodiments, the vehicle pad is configured during manufacturing to provide a desired conversion ratio among the ground pad coil 332 on the ground pad and the vehicle pad coil 330 on the vehicle pad by using jumpers or any other suitable electrical connectors to connect (and/or disconnect) power electronics components on a PCB of the vehicle pad. For example, a jumper may be attached to a PCB associated with the vehicle pad to connect two points on the PCB for configuring the wireless charging DC/DC converter from a first conversion ratio (e.g., 16) to a second conversion ratio (e.g., 32). As another example, a jumper that is attached to the PCB may be removed from the PCB to configure the wireless charging DC/DC converter for providing different conversion ratios based on different battery charging voltages specified by different batteries. In some embodiments, different forms of jumpers and/or connectors (e.g., jumper wire) can be utilized to configure the wireless charging DC/DC converter to a circuit topology that is different from the circuit topology 300A and the circuit topology 300B for achieving different levels of input and output voltages.

In the circuit topologies 300A and 300B, the half bridge connected to a negative tank node 304A or 304B (e.g., HVTANK-) is connected to different nodes. In particular, the half bridge including transistors 364 and 366 connected to the negative tank node 304A in the vehicle pad of FIG. 3A is connected between nodes HV+and HV-MID. In contrast, the half bridge including transistors 364 and 366 connected to the negative tank node 304B in the vehicle pad of FIG. 3B is connected between nodes HV-MID and HV-. During manufacture, the half bridge including transistors 364 and 366 can be connected as shown in FIG. 3A or as shown in FIG. 3B. This can involve connecting the half bridge using jumpers. In certain applications, the vehicle pad can be provided with the half bridge preconfigured either as shown in FIG. 3A or as shown in FIG. 3B and adjusted as desired to a different configuration during manufacture.

Advantageously, by using instances of the same hardware (e.g., same transistors, same coil, same capacitors) for vehicle pads with different conversion ratios, while utilizing PCB connectors costs can be reduced for building vehicle pads and/or wireless charging systems. Additionally, the vehicle pads and/or wireless charging systems may become more light weight as less hardware can be involved for charging different battery packs. Further, the complexity of designing the wireless charging systems to meet different input and output voltage specifications can be reduced by using the same coils and capacitors in the wireless charging DC/DC converters with different conversion ratios.

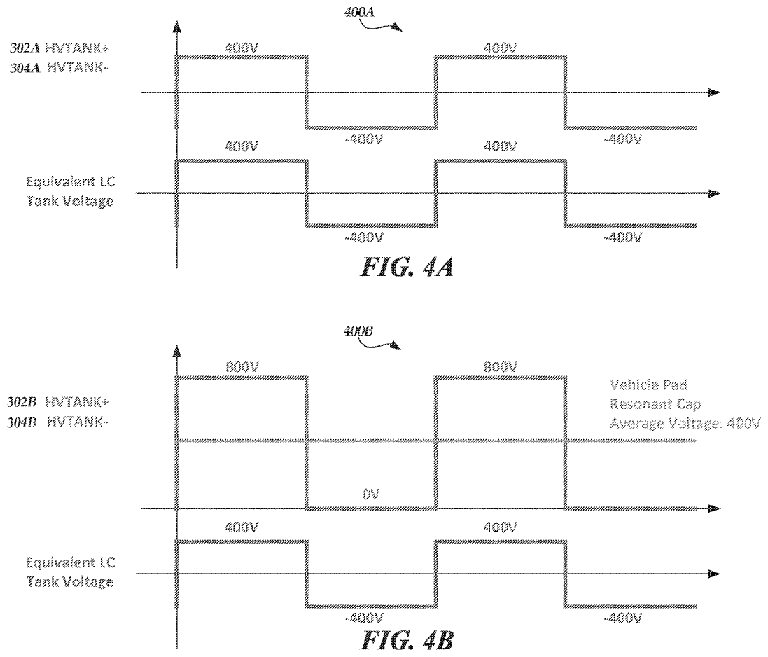

FIGS. 4A-4B show example waveforms 400A and 400B illustrating operations of the circuit topology 300A and circuit topology 300B in accordance with some embodiments of the present disclosure. The waveforms 400A and 400B are generated based on synchronous rectification operation on the vehicle pad side. A vehicle pad can be configured during manufacturing and used with a ground pad to exhibit one of the waveforms 400A and the waveforms 400B to provide various voltages (e.g., 400V and 800V) for charging various battery packs. Advantageously, the same set of hardware (e.g., coils, transistors, resonant capacitors, or the like) arranged into various circuit topologies can provide various battery voltage ranges within a wide range without an additional DC/DC converter, unlike the wireless charging system 200A and the wireless charging system 200B.

FIG. 4A shows an example waveform illustrating the operation of the circuit topology 300A of FIG. 3A. As shown in FIG. 4A, a voltage across a positive tank node 302A (e.g., HVTANK+) and a negative tank node 304A (e.g., HVTANK−) has a maximum voltage of 400 V and a minimum voltage of −400V. The circuit topology 300A may be utilized to charge a 400V battery pack.

FIG. 4B shows an example waveform illustrating the operation of the circuit topology 300B of FIG. 3B. As shown in FIG. 4A, a voltage across a positive tank node 302B (e.g., HVTANK+) and a negative tank node 304B has a voltage swing of 800 V, with a maximum voltage of 800 V and a minimum voltage of 0 V. The circuit topology 300B may be utilized to charge a 800V battery pack.

### Example Bidirectional Shorting Switch

During operations of a wireless charging converter (e.g., a DC/DC converter comprising the circuit topology 300A or the circuit topology 300B), leakage current may be generated across a vehicle pad coil 330 and/or a ground pad coil 332. For example, the ground pad coil 332 of FIG. 3A may generate a leakage current associated with the ground pad. This leakage current can flow through a parasitic capacitor (not shown in FIG. 3A) to a heat sink (not shown in FIG. 3A) associated with the circuit topology 300A. As another example, the vehicle pad coil 330 of FIG. 3A may generate a leakage current associated with the vehicle pad. This leakage current can flow throw a parasitic capacitor (not shown in FIG. 3A) to a heat sink (not shown in FIG. 3A) associated with the circuit topology 300A. More specifically, when the vehicle pad coil 330 is operating, a common mode voltage swing may appear across the nodes 302A and 304A. The common mode voltage swing across the vehicle pad coil 330 may cause the leakage current to flow through the vehicle pad coil 330.

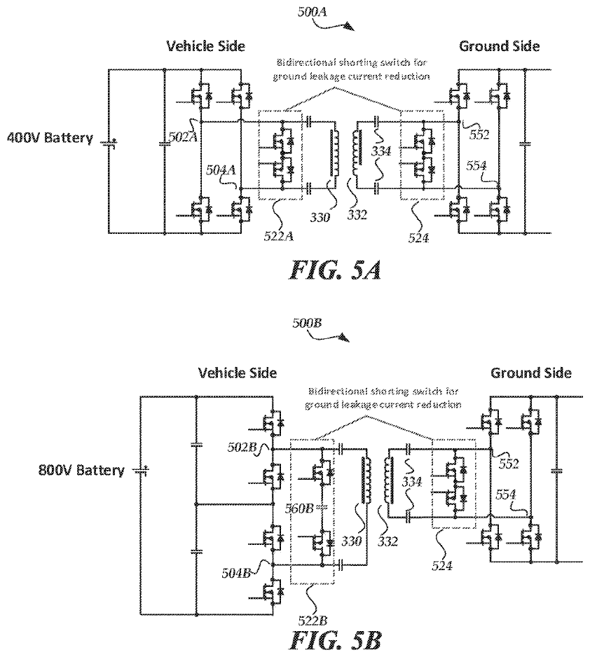

To reduce the leakage current, one or more bidirectional shorting switches can be included in a wireless charging DC/DC converter. For example, the one or more bidirectional shorting switches can be added to the circuit topology 300A and/or the circuit topology 300B to arrive at circuit topologies shown in FIGS. 5A-5B, respectively. The one or more bidirectional shorting switches can reduce leakage currents flowing to heat sink(s) through parasitic capacitance associated with the circuit topology 300A and/or circuit topology 300B. As noted above, the leakage currents may be generated by the vehicle pad coil 330 and/or the ground pad coil 332 (e.g., due to common mode voltage swings resulting from operations of the circuit topology 300A or the circuit topology 300B). The one or more bidirectional shorting switches can block or reduce the common mode voltage swings such that a constant common mode voltage or a relatively constant common mode voltage can be reached across the vehicle pad coil 330 and the ground pad coil 332, thereby reducing leakage currents. With a bidirectional shorting switch, current can flow in either direction across the bidirectional shorting switch.

Advantageously, with reduced leakage currents, less energy can be dissipated than in the circuit topology 300A and the circuit topology 300B. Additionally, conducted and radiative emissions may also be reduced or minimized.

FIGS. 5A-5B illustrate an example circuit topology 500A and an example circuit topology 500B of a wireless charging DC/DC converter. The circuit topology 500A is like the circuit topology 300A of FIG. 3A, except bidirectional shorting switches are included in the circuit topology 500A. The circuit topology 500A may function the same or similarly to the circuit topology 300A except for the functionality (e.g., leakage current reduction through reducing a common mode voltage swing) provided by a bidirectional shorting switch. The circuit topology 500B is like the circuit topology 300B of FIG. 3B, except that bidirectional shorting switches are included in the circuit topology 500B. The circuit topology 500B may function the same or similarly to the circuit topology 300B except the functionality (e.g., leakage current reduction through reducing a common mode voltage swing) provided by a bidirectional shorting switch.

As shown in FIG. 5A, a bidirectional shorting switch 522A is shunted across a vehicle pad coil 330, and a bidirectional shorting switch 524 is shunted across a ground pad coil 332. The circuit topology 500A represents an H bridge converter topology with bidirectional shorting switches. With the H bridge converter, the bidirectional shorting switch 524 can be coupled in-between switching nodes 552 and 554, thereby providing a shunt path to apply a zero voltage across a resonant tank. The resonant tank can include the ground pad coil 332 and capacitors 334 as illustrated in FIG. 5A. With the bidirectional shorting switch 524, a constant common-mode voltage on the ground pad coil 332 can be achieved. This can reduce leakage current across the resonant tank that includes the ground pad coil 332.

Similarly, a bidirectional shorting switch 522A for ground current leakage current reduction can be implemented on a vehicle pad of the circuit topology 500A. The battery pack on the vehicle side can have a relatively high voltage, such as a 400 Volt maximum voltage. The bidirectional shorting switch 522A can be coupled in between switching nodes 502A and 504A, thereby achieving a generally constant common-mode voltage across the vehicle pad coil 330 to reduce a leakage current.

As illustrated in FIG. 5A, each of the bidirectional shorting switch 522A and the bidirectional shorting switch 524 can include at least two field effect transistors (FETs), such as MOSFETs, connected serially in a back-to-back manner. The bidirectional shorting switches 522A and 524 are each illustrated as including two FETs arranged in series between two nodes with sources connected to each other. As such, the bidirectional shorting switch 522A is capable of reducing or eliminating voltage swings of both polarities across the nodes 502A and 504A (i.e., a positive voltage swing between the nodes 502A and 504A, and a negative voltage swing between the nodes 502A and 504A). Alternatively, a bidirectional shorting switch can include two FETs arranged in series between two nodes with drains connected to each other. The bidirectional shorting switches 522A and 524 can include N-type transistors as illustrated. In some other instances, bidirectional shorting switches 522A and 524 can include P-type transistors. The bidirectional shorting switch 524 is capable of reducing or eliminating voltage swings of both polarities across the nodes 552 and 554 (i.e., a positive voltage swing between the nodes 552 and 554, and a negative voltage swing between the nodes 552 and 554). In some embodiments, current can flow in either direction across the bidirectional shorting switches 522A and 524 when the bidirectional shorting switches 522A and 524 are closed, and current can be blocked in either direction across the bidirectional shorting switches 522A and 524 when the bidirectional shorting switches 522A and 524 are open.

As shown in FIG. 5B, a bidirectional shorting switch 522B is shunted across a resonant tank that includes a vehicle pad coil 330, and a bidirectional shorting switch 524 is shunted across resonant tank that includes a ground pad coil 332. The bidirectional shorting switch 524 can be coupled in-between switching nodes 552 and 554, thereby providing a shunt path to apply a zero voltage across a resonant tank. The resonant tank can include the ground pad coil 332 and capacitors 334 as illustrated in FIG. 5B. With the bidirectional shorting switch 524, a constant common-mode voltage on the ground pad coil 332 can be achieved.

Similarly, a bidirectional shorting switch 522B for ground current leakage current reduction can be implemented on a vehicle side of the circuit topology 500B. The battery pack on the vehicle side can have a relatively high voltage, such as a 800 Volt maximum voltage. The bidirectional shorting switch 522B can be coupled in between switching nodes 502B and 504B, thereby achieving a constant common-mode voltage across the vehicle pad coil 330 to reduce a leakage current.

As illustrated in FIG. 5B, each of the bidirectional shorting switch 522B and the bidirectional shorting switch 524 can include at least two field effect transistors (FET), such as MOSFETs, connected serially in a back-to-back manner. As such, the bidirectional shorting switch 522B is capable of reducing or eliminating voltage swings of both polarities across the nodes 502B and 504B (i.e. a positive voltage swing between the nodes 502B and 504B, and a negative volage swing between the nodes 502B and 504B). The bidirectional shorting switch 524 is capable of reducing or eliminating voltage swings of both polarities across the nodes 552 and 554 (i.e., a positive voltage swing between the nodes 552 and 554, and a negative volage swing between the nodes 552 and 554).

As shown in FIG. 5B, the circuit topology 500B on a vehicle side represents stacked half bridges that include two half bridges in serial with each other (e.g., four FETs serially stacked). A flying capacitor 560B can be connected in series between the two FETs in the bidirectional shorting switch 522B, thereby providing a shunt path to apply half of a direct current (DC) bus voltage on a resonant tank that is decoupled from DC bus so as to achieve constant common-mode voltage across the vehicle pad coil 330. In some other embodiments, a stacked half bridge topology with a flying capacitor can be implemented on a ground side.

Bidirectional shorting switches disclosed herein can reduce inductive charging ground leakage current in any of the wireless charging pads disclosed herein. A bidirectional switch connected in between switching nodes can be used to short the resonant tank, so that the common-mode voltage on a coil is relatively constant and stable. The bidirectional shorting switches can be implemented any of the vehicle pads and/or any of the ground pads disclosed herein.

The wireless charging circuitry disclosed herein can be implemented with one or more bidirectional switches and/or one or more other techniques to reduce charging ground leakage current. Such other techniques include, but are not limited to, (1) a segmented coil to make multiple LC resonators in series to reduce the common-mode voltage on the coil, and (2) an additional DC/DC converter onboard and offboard to avoid duty cycle control of the wireless power transfer power stage, and thus to reduce the common-mode voltage on coil. For example, any of the coils disclosed herein can be a segmented coil to make multiple LC resonators in series. Such a segmented coil can be implemented in any of the wireless charging pads disclosed herein, such as in any of the ground pads and/or vehicle pads of any of FIGS. 3A, 3B, 5A, and/or 5B.

### Conclusion

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z.). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A wireless charging pad with reduced leakage current, the wireless charging pad comprising:
a resonant tank having a first tank terminal and a second tank terminal, the resonant tank comprising a coil; and
a bidirectional switch having a first switch terminal and a second switch terminal, the first switch terminal connected to the first tank terminal and the second switch terminal connected to the second tank terminal,
wherein the bidirectional switch is configured to cause a common mode voltage across the coil to be reduced, and
wherein the wireless charging pad is configured for wireless power transfer.

2. The wireless charging pad of claim 1, wherein the bidirectional switch comprises a first transistor and a second transistor, wherein the first transistor and the second transistor are connected back-to-back.

3. The wireless charging pad of claim 2, wherein the first transistor and the second transistor are field effect transistors (FETs), wherein a drain of the first transistor is connected to the first switch terminal, wherein a drain of the second transistor is connected to the second switch terminal, and wherein a source of the first transistor and a source of the second transistor are connected to each other.

4. The wireless charging pad of claim 1, further comprising a H bridge circuit, wherein the first tank terminal and the first switch terminal are connected to a first switching node of the H bridge circuit, and wherein the second tank terminal and the second switch terminal are connected to a second switching node of the H bridge circuit.

5. The wireless charging pad of claim 1, further comprising a stacked half bridge circuit, wherein the first tank terminal and the first switch terminal are connected to a first switching node of the stacked half bridge circuit, and wherein the second tank terminal and the second switch terminal are connected to a second switching node of the stacked half bridge circuit.

6. The wireless charging pad of claim 5, wherein the stacked half bridge circuit comprises a first half bridge comprising field effect transistors, and a second half bridge comprising field effect transistors.

7. The wireless charging pad of claim 6, wherein one field effect transistor of the first half bridge and one field effect transistor of the second half bridge are connected in series between the first switching node and the second switching node.

8. The wireless charging pad of claim 1, wherein the bidirectional switch comprises two field effect transistors connected back-to-back.

9. The wireless charging pad of claim 8, wherein the bidirectional switch further comprises a capacitor connected in series between two field effect transistors.

10. The wireless charging pad of claim 1, wherein the coil is a segmented coil.

11. The wireless charging pad of claim 1, wherein the wireless charging pad is a vehicle pad comprising terminals configured to connect to a battery pack.

12. The wireless charging pad of claim 1, wherein the wireless charging pad is a ground pad comprising an electrical connector configured to connect to a power source.

13. A method of wireless power transfer with reduced leakage current, the method comprising:
energizing a ground pad; and
wirelessly transferring power from the ground pad to a vehicle pad of a vehicle,
wherein the vehicle comprises a battery pack and is configured to charge the battery pack based on the wirelessly transferring power, and
wherein at least one of the vehicle pad or the ground pad comprises a bidirectional shorting switch across a resonant circuit.

14. The method of claim 13, wherein the bidirectional shorting switch comprises a first transistor and a second transistor, wherein the first transistor and the second transistor are connected back-to-back.

15. The method of claim 14, wherein the bidirectional shorting switch further comprises a capacitor connected in series between the first transistor and the second transistor.

16. The method of claim 13, wherein the resonant circuit comprises an inductive coil and one or more resonant capacitors.

17. The method of claim 13, wherein the vehicle pad is configured to provide a voltage of up to 800 Volts to the battery pack.

18. A wireless charging converter comprising:
a first resonant tank comprising a first coil; and
a first electrical switch shunted across the first resonant tank,
wherein the first electrical switch is configured to cause a common mode voltage across the first coil to be reduced for wireless charging.

19. The wireless charging converter of claim 18, further comprising.
a second resonant tank comprising a second coil; and
a second electrical switch shunted to the second resonant tank,
wherein the second electrical switch is configured to adjust a second common mode voltage on the second coil for charging a battery pack of a vehicle.

20. The wireless charging converter of claim 19, wherein the first resonant tank and the first electrical switch are in a vehicle pad attached to the vehicle, and where the second resonant tank and the second electrical switch are in a ground pad that is connected to an energy source for charging the battery pack of the vehicle.

21. The wireless charging converter of claim 19, wherein the first electrical switch comprises two field effect transistors (FETs) connected back-to-back.

22. The wireless charging converter of claim 21, wherein the second electrical switch comprises two additional FETs and a capacitor connected in series between the two additional FETs.

23. The wireless charging converter of claim 19, wherein the second electrical switch comprises two additional transistors connected back-to-back.

24. A wireless charging system comprising the wireless charging pad of claim 1.
